(19) United States
(12) Patent Application Publication
(10) Pub. No.: US 2019/0077033 A1
(43) Pub. Date: Mar. 14, 2019

(54) HAIR REMOVAL DEVICE FOR PUBIC HAIR

(71) Applicant: The Gillette Company LLC, Boston, MA (US)

(72) Inventor: Matthew James Hodgson, Ramsbury (GB)

(21) Appl. No.: 16/127,745

(22) Filed: Sep. 11, 2018

(30) Foreign Application Priority Data
Sep. 11, 2017 (EP) 17190429.5
Jul. 27, 2018 (EP) 18186054.5

(51) Int. Cl. B26B 21/40; B26B 21/18; B26B 21/52; B26B 21/44

(52) U.S. Cl. CPC B26B 21/4031; B26B 21/44; B26B 21/52; B26B 21/18

(57) ABSTRACT

The invention relates to a hair removal device for the effective removal of hair from the sensitive pubic (e.g. bikini) region of the body especially for female consumers, whilst minimizing the associated post hair removal irritation.

### FIELD OF THE INVENTION

The invention relates to a hair removal device for the effective removal of hair from the sensitive pubic (or bikini) region of the body especially for female consumers, whilst minimizing the associated post hair removal irritation.

### BACKGROUND OF THE INVENTION

Products for the removal of unwanted hair from the body have been commercially available for many years. These products have focused primarily on facial, underarm and leg hair removal. There is however a growing desire from consumers for removal of hair for other areas of the body including intimate areas such as the pubic areas including the bikini area. Whilst a number of products are commercially available for hair removal at the bikini area, they are not particularly satisfactory and consumers still tend to use hair removal products designed for the removal of hair from traditional areas such as axilla and legs.

The removal of hair from the pubic area creates a number of challenges to the manufacturer of such products. In particular, the ability to fully remove all pubic hair to skin level without irritation remains a key unmet need for male and female shavers. The complex anatomical curves in the pubic area also present a specific challenge, in addition to the skin mobility in this area. Moreover, the nature of the hair in this area, also differs to that in other body sites, in terms of elevation angle, fiber shape and diameter. Therefore, hair removal devices available for the legs and underarms are not particularly effective at removal of pubic hair.

The primary benefit of a pubic or bikini product is to cut hairs to or below skin level with minimal insult and subsequent side-effects to the surrounding skin. However, women indicate that they continue to experience significant side-effects when shaving in this area such as irritation, in the form of redness (erythema), bumps, ingrown hairs, itchiness and soreness. These side effect may also manifest themselves immediately after shaving and or hours or even days after the shaving event has occurred.

Commercially available products do not address these particular needs and typically are often simply provided as a generally smaller product to aid ease of handling of the device in the restricted bikini area.

WO2012/061343 describes a razor cartridge wherein the angle between the primary blade and the blade plane is greater than the angle between the final blade and the blade plane of the blade array to improve the balance between closeness and comfort of a shave.

There is thus still a need to provide a hair removal device for the pubic hair area, which effectively cuts the hair type in this area in a safe, easy and efficient manner such that the user of the device is confident during use and thereby ensures improved hair removal end result whilst reducing any associated irritation.

### SUMMARY OF THE INVENTION

The invention relates to a shaving razor (10) comprising a cartridge (12) comprising a housing (16) having a front portion (18) and a rear portion (20), a guard (30) at the front portion (18) of said housing (16) and a cap (32) at the rear portion (20) of the housing (16) and a blade array (26) located in-between the guard (30) and cap (32), wherein the blade array (26) comprises at least two blades, a primary blade (40) and a final blade (44), each blade (26) having a blade edge (48, 50) that extends parallel to the housing (16); having a blade plane x tangential to the primary blade edge (48) and the final blade edge (50), wherein each angle between each blade (26) and the blade plane x is 50° or greater.

The invention also relates to the use of a razor cartridge according to claim 1, for the removal of hair from the pubic area, preferably the bikini area.

### BRIEF DESCRIPTION OF THE DRAWINGS

FIGS. 1a & 1b are perspective views of a first embodiment of the invention

FIG. 2 is a back view of the first embodiment of FIG. 1.

FIG. 3 is a front view of the first embodiment of FIG. 1

FIG. 4 is a side view of the first embodiment of FIG. 1.

FIG. 5 is a schematic view of a blade from an embodiment of the invention

FIG. 6 is a schematic cross-sectional view of the cartridge of an embodiment of the invention

FIG. 7 is a schematic cross section view of a blade tip cutting a hair

FIG. 8 showing a top view of a cartridge of the first embodiment of the invention.

### DETAILED DESCRIPTION OF THE INVENTION

Hair Removal Head

The present invention relates to a shaving razor cartridge which may be replaceable or permanently attached to a handle. The cartridge may be pivotally connected via a cartridge connecting structure to the handle or in a fixed position. In some embodiments, the cartridge connecting structure includes at least one arm to releasably engage the cartridge.

The cartridge typically comprises 1, 2, 3, 4 or 5 elongated blades edges usually positioned between a first and second end, said one or more elongated blade edges comprising a tip extending towards said first end. Additionally, the razor cartridge may include a guard as well as a skin engaging member and one or more lubricating members. A variety of razor cartridges can be used in accordance with the present invention.

In some embodiments, at least one lubricating member is located on the portion of the cartridge that contacts skin during the hair removal process, forward and/or aft of the blades. A feature “forward” of the one or more elongated edges, for example, is positioned so that the surface to be treated with by the hair removal device encounters the feature before it encounters the elongated edges. A feature “aft” of the elongated edge is positioned so that the surface to be treated by the hair removal device encounters the feature after it encounters the elongated edges. Where more than one lubricating member is provided on the hair removal device, they can be the same (identical) or different, in terms of physical shape/structure and/or chemical composition.

In some particular embodiments, a plurality (e.g. 2, a first and second) of lubricating members may be provided on the cartridge, with the first skin engaging member comprising the same composition or different. These lubricating members may be placed collectively (for example adjacent to one another) ahead of or behind the elongated edges (e.g. blades on a razor cartridge), including side by side, or separately with one ahead of the elongated edges and the other behind.

The lubricating member may be free standing utilizing a suitable attachment means such as adhesive or may be contained at least partially within a container.

In some embodiments, the cartridge comprises a guard comprising at least one elongated flexible protrusion to engage a user's skin. The at least one flexible protrusion may comprise flexible fins generally parallel to said one or more elongated edges. Said at least one flexible protrusion may additionally or alternatively comprise flexible fins comprising at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); 2009/0049695A1 (disclosing an elastomeric guard having guard forming at least one passage extending between an upper surface and a lower surface). In some embodiments, said lubricating member is positioned on the cartridge aft of the guard and forward of said elongated edge. In another embodiment, the lubricating member is positioned on the cartridge forward of the guard.

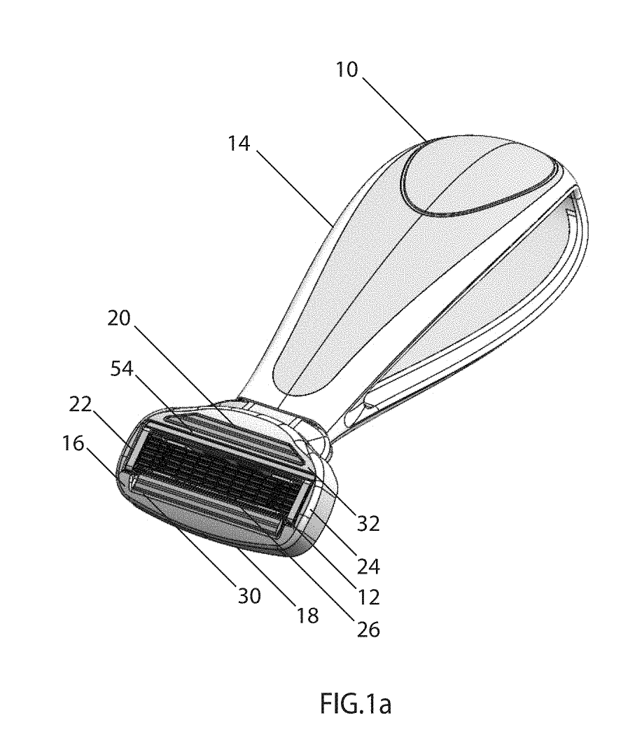

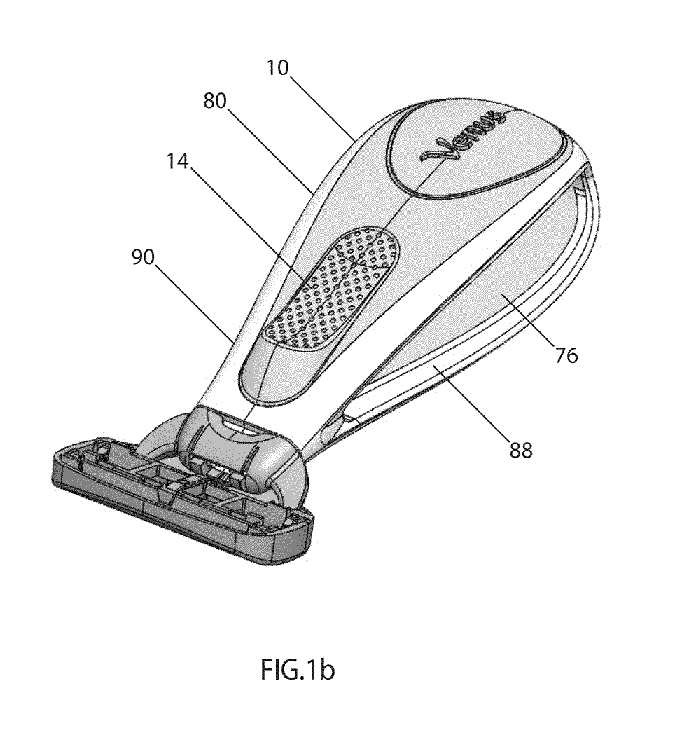

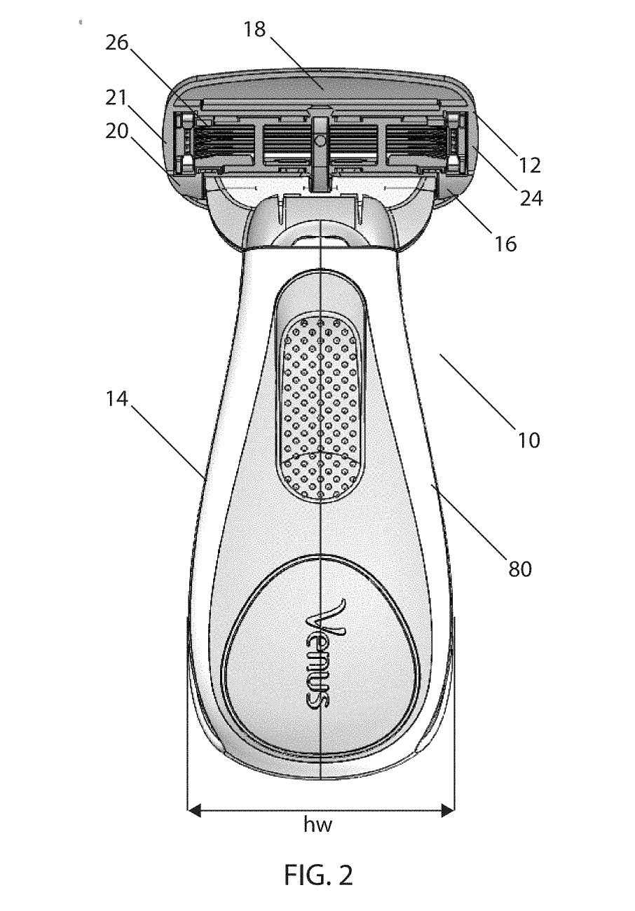

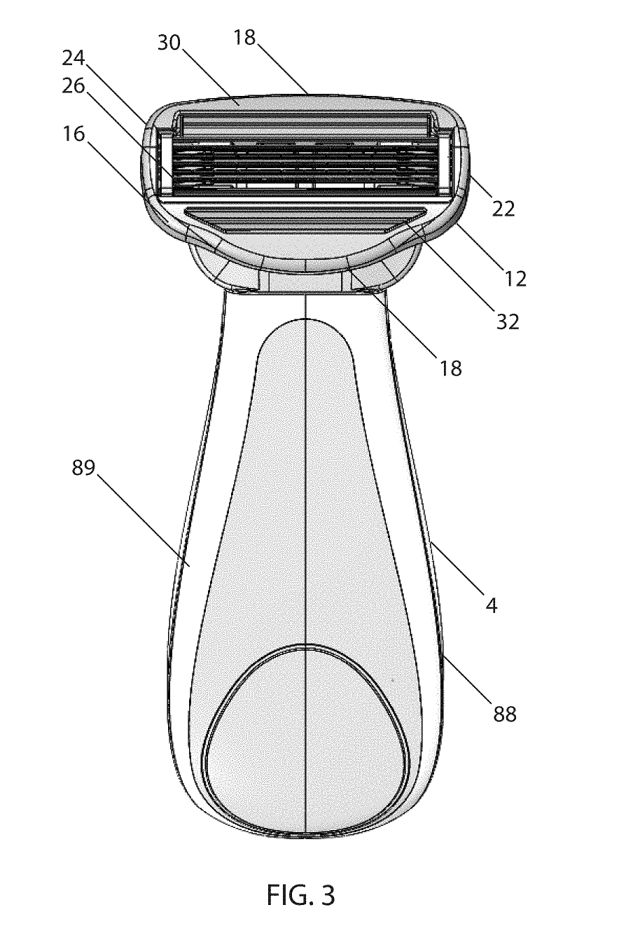

FIGS. 1a and 1b show a wet shaving razor 10 formed of a razor cartridge 12 attached to a handle 14. The razor cartridge is formed of a housing 16 having a front 18, a rear 20 and first and second opposing side walls 22, 24 disposed transverse to and between the front wall and rear wall. Two or more blades 26 with sharp cutting edges 28 are mounted within the housing 16 and extend between the first and second opposing side walls 22, 24. In embodiments, the razor cartridge 12 has a first skin contact point, typically a guard 30, located ahead of the blades and a second skin contact point, typically a cap 32, located behind the blades. In the embodiment shown, the guard is disposed at the front of the housing and the cap is disposed at the rear of the housing. However, it will be appreciated that, in an alternative embodiment, the respective positioning of the guard and cap may be reversed or the guard may be formed separately to the housing and mounted directly to the razor handle. Lubricating members (54) are located forward and aft of the blades.

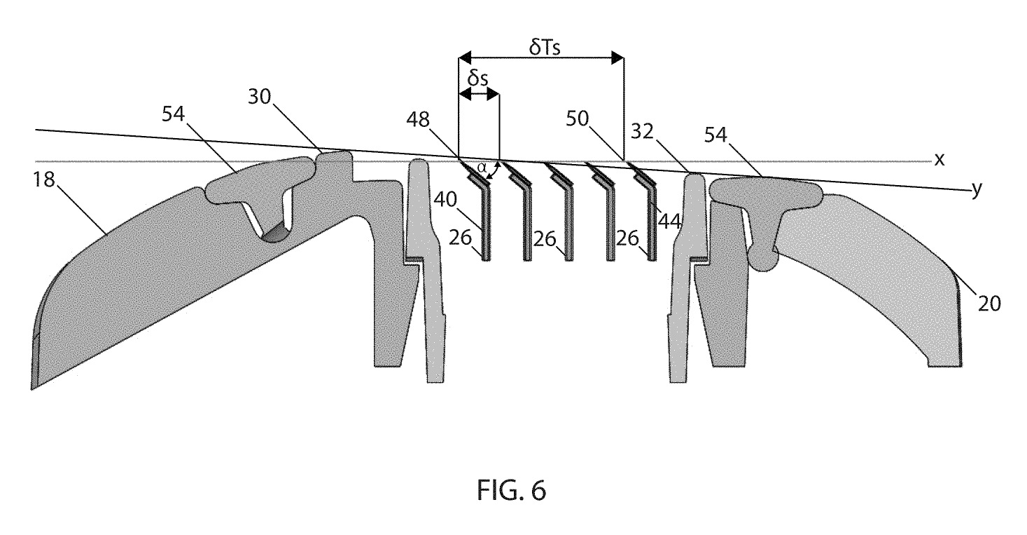

FIGS. 1a & 1b show an arrangement of blades in a cartridge having five blades 26. While this figure is shown with five blades, it will be appreciated that the cartridge could have fewer or more blades. FIG. 6 shows a schematic cross-section through a cartridge shown in FIG. 1a. A primary blade 40 is located adjacent the guard 30 at the front end 18 of the cartridge and a final blade 44 is located adjacent the cap 32 at the rear end 20 of the cartridge. Each of the blades has a respective blade edge (e.g. the primary blade edge 48 and final blade edge 50) that extends in parallel to the length of the cartridge. The blade edges lie on a blade plane x that is tangential to the primary blade edge 48 and the final blade edge 50. The blades 40, 44 extend away from the front end 18 of the cartridge at an angle α beneath the blade plane x.

A span δs is defined between each pair of adjacent blade edges, and a total span δts is defined between the primary blade edge 48 and the final blade edge 50. The span between adjacent blade edges may be the same for each pair of blades in a cartridge, or the span between adjacent blade edges may vary at different points in the cartridge. For example, in a three-blade cartridge having a primary, second and final blade, the span between the primary and second blade edges may be less than, equal to or greater than the span between the second and final blade edges.

Each of the blades 40, 44 extends away from the blade plane x at an angle αp relative to the blade plane x. The present inventors have found that by providing the blades at an angle of at least 50°, it is possible to further reduced irritation and improve the closeness for the removal of pubic hair.

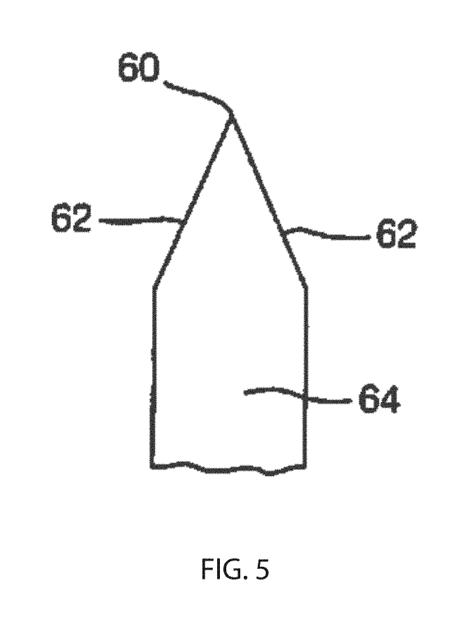

A typical blade edge is shown in FIG. 5, having a sharp tip 60 and facets 62 that extend away from the sharp tip into a body 64 of the blade. While shaving pubic (bikini) hair, a user is likely to experience varying degrees of comfort/discomfort depending on how much of the blade edge is presented to the skin. As the angle α is increased, the surface area of the blade presented to the skin decreases and thus the pressure on the skin increases, leading to an increase in discomfort experienced by a user. As the angle α is decreased, more of the facet 62 is presented to the surface of the skin, increasing the surface area of the blade presented to the skin and a user experiences less discomfort.

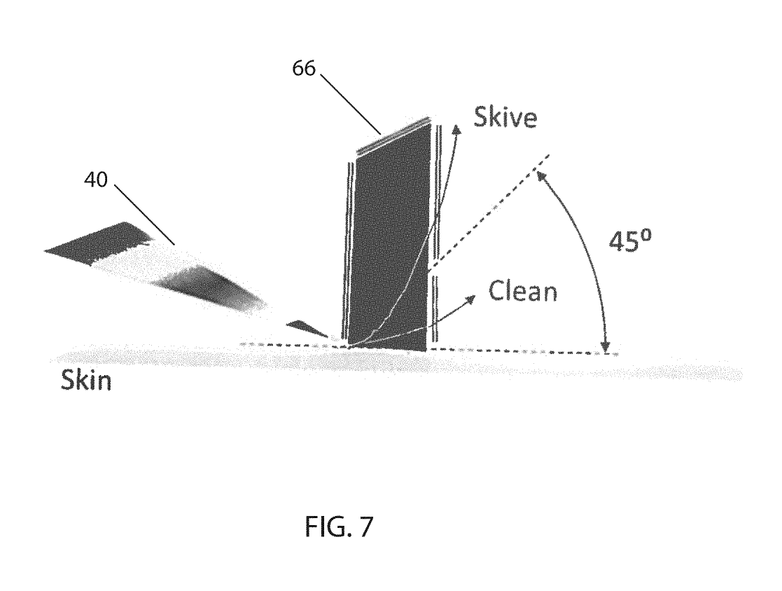

However, as explained above, there is a trade-off between the increase in comfort and a decrease in efficiency and closeness of a shave. In this respect, as the angle α is decreased, there is a greater likelihood that contact between a blade edge and a hair will result in a “skive-cut”. A skive-cut occurs when the resultant angle of the cut hair tip is greater than 45° to the normal of the hair fibre (66), as shown in FIG. 7 leaving one side of the hair longer than the other side. By not cutting a hair cleanly, a user may need to shave more frequently, or increase the number of shaving strokes. In contrast, as the blade angle α is increased, there is less chance that contact between a blade edge and hair will result in a skive-cut. This is of particular importance in the pubic (bikini) area where hairs are more likely to grow at a low elevation angle in relation to the skin, and are thus more likely to lay flat to the skin, especially considering the anatomical skin folding in this body site, and the wearing of close fitting undergarments. Such skive cut hairs have a fine and pointed tip shape and are thus more prone to cause sensory irritation (tickle, itch) and also are more likely to re-penetrate the skin resulting in inflammation or irritation response, when lying flat to skin.

The present inventors have found that increasing the blade angle to an angle of at least 50°, ensures both the desired comfort in use, and a reduction in proportion of skive cut hairs. This results in a decrease in irritation occurring post shaving for pubic hair removal. Consequently, the primary blade and all additional blades are independently positioned at an angle αp of a least 50°, preferably at an angle αp from about 50° to about 60°, more preferably at an angle αp about 50°. Preferably the blades are all at the same blade angle.

Whilst not being bound by theory, the Applicants believe that redness, bumps and ingrown hairs are related (at least in part) to low lying hairs being cut so that they have a resultant angled tip shape. An angled hair tip shape can be compared in dimension to the tip of a microneedle, a device specifically designed to puncture the skin. The relationship between insertion force and tip shape (in the context of microneedles) is such that an angled tip shape can be inserted into the skin with much lower force than a blunt tip shape.

Applying this analogy to hair tip shapes, the Applicant believes that hairs with a blunt tip shape require significantly more insertion force to re-enter the skin post shaving, and therefore are less able to do so and hence less likely to trigger the associated cycle of irritation. The Applicant has found that bikini hair can be cut to form a blunt hair tip by the use of blade edges inclined at a higher angle to the skin, versus the standard angle in common commercially available razor cartridges.

FIG. 6 shows a skin contact plane y which is tangential to skin engaging surfaces of the guard 30 and cap 32. “Exposure” of a blade is defined as the distance, p, of the blade edge 28 from the exposure plane. Where a blade edge lies beneath the exposure plane, this is classified as a “negative exposure”. If the blade lies above the exposure plane, this is classified as a “positive exposure”. If the blade edge lies in the exposure plane, the blade edge has zero exposure.

In one embodiment not shown, the primary blade 40 has negative exposure, the final blade 44 has positive exposure and the exposure of any additional blades between the primary and final blades have progressively increasing exposure from the front to rear of the cartridge. This form of progressive geometry is described in detail in EP 0 722 379. Variation in blade exposure across a cartridge results in a varied load distribution across the blades of a cartridge. The load on respective blades reduces as the exposure is reduced. Accordingly, in such an embodiment, least load is applied to the primary blade during shaving while most load is applied to the final blade. This is a result of the pressure applied to skin by the blades during shaving—where the blade protrudes more relative to the exposure plane, effectively the skin contact plane, while shaving, the blade protrudes further into skin.

The blades of the present invention may be secured to the housing in any known way, for example, the blades may be attached to blade supports, or they may be bent blades that are secured directly to the housing. In embodiments of the present invention, the housing has a blade retaining member having a plurality of slots for receiving either the blade supports or, where bent blades are used, the blades. The angle of the respective blades relative to the blade plane x can be determined by an angle in the blade support, where blade supports are used, or by a bend in a blade where bent blades are used. Alternatively, the angle of bend in the respective blade supports or bent blades may be kept the same, and the angle of the respective slots in the blade retaining member may be varied to result in blade edges at varying angles to the blade plane x.

In typical cartridges, the blades are usually carried by the housing, which is generally a molded plastic frame, either independently of each other or in unison under forces imparted on the blades by the skin during shaving. In one embodiment of support within the housing, the blades are mounted fixedly within slots in a blade retaining member. In most instances, there will be one or more rigid blade retaining member disposed along a length of the housing to provide adequate and immovable support for the blades disposed therein. In another instance, the blades may be floatably mounted within the housing. Here, the plurality of blades is supported by one or more spring loaded blade retaining member where the blades are permitted to respond to the forces encountered during shaving.

Razor Cartridge

The Applicant has further found that the overall hair removal performance of the blades as discussed hereinabove, is not effective if contact between the skin and blade is not achieved and maintained during the shaving process. The pubic area unlike the face and legs for example is not however fully and readily visible to the consumer conducting the hair removal process. Consequently, the consumer is more reliant on tactile responses in order to try and achieve the desired hair removal result without causing injury.

The Applicant has surprisingly found that the overall size and dimensions of the cartridge hereinafter referred to as the cartridge footprint can improve cartridge fit and also improve contact in the bikini area particularly with regard to skin mobility. This aids greater precision and efficiency of hair removal in this area and importantly ensures the appropriate blade contact with the skin. Whilst not bound by theory, the Applicant also believes that the footprint allows consumers to achieve the desired hair removal in fewer strokes and or overstrokes, thus reducing the extent of skin insult and the associated irritation.

The footprint or skin contacting surface is define by the peripheral edge of the housing (34). The cartridge may have a skin contact surface area or footprint of from about 600 mm² to 800 mm², preferably from about 620 mm² to 750 mm², more preferably from between about 635 mm and 650 mm² or from about 725 mm² to 745 mm². The cartridge may have a maximum length (c₁) of from about 30 mm to 60 mm, preferably from about 35 mm to about 50 mm, more preferably from about 40 mm to 45 mm. The cartridge may have a maximum width (c_{w}) of from about 15 mm to 25 mm, preferably from about 20 mm to 25 mm.

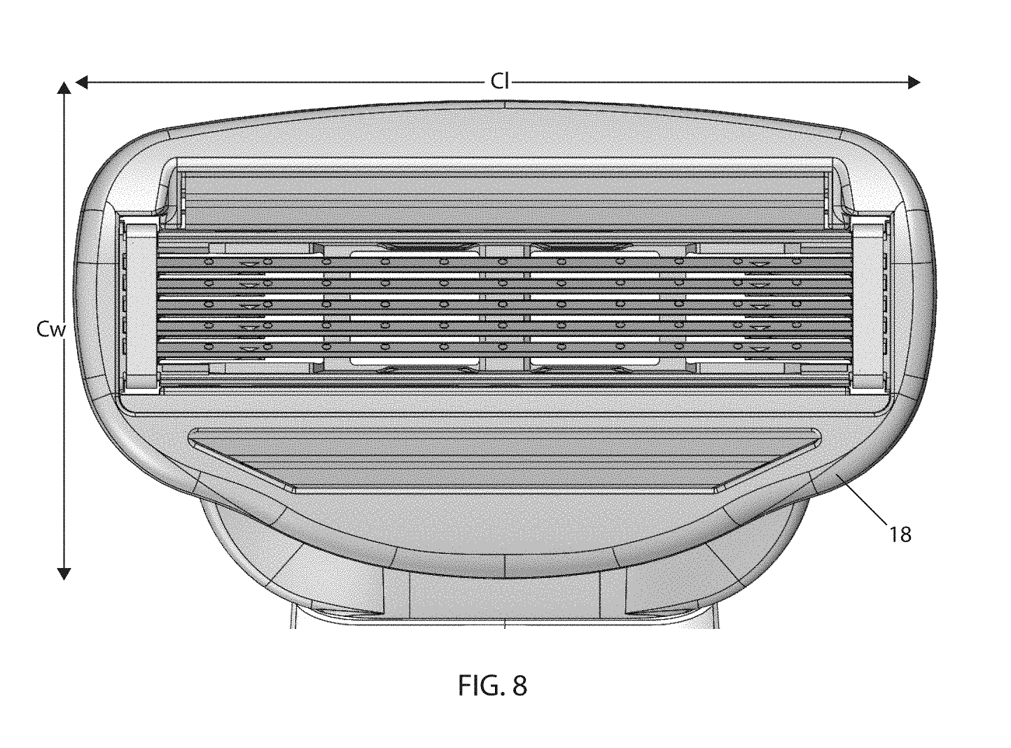

The cartridge may be provided in a generally regular rectangular or oval shape. However, in one embodiment the cartridge may be provided such that the front portion of the cartridge is shorter than the rear portion of the cartridge as shown in FIG. 8. The front and rear portions of the cartridge are defined by the cartridge housing. In such embodiments the front and rear portions are preferably joined by curved side walls. The shorter front portion is typically centered. In one embodiment the aspect ratio of the front and rear portions is between 2 and 1. Whilst not being bound by theory it is believed that having a shorter front portion aids in the smooth flow of the cartridge across the mobile skin present in the pubic area.

Whilst not being bound by theory, the Applicant has found that the size and dimensions of the cartridge may judiciously mitigate the discomfort arising from the increase blade tip pressure when blades are present at an elevated angle. The smaller footprint size increases the ratio of housing materials to lubricant in contact with skin during a shaving stroke, resulting in a reduction in perceived dragging which can cause discomfort. Moreover, the preferred footprint also readily conforms and fits the curves of the bikini body site and thereby enables hairs to be captured efficiently and comfortably with the increased blade angles.

Handle

The Applicant has also found that the handle can also improve the overall shaving performance in the bikini area in combination with high blade angle geometry. In addition to providing its key role to ensure a secure grip, the Applicant has found that the relative length and width of the handle enables the user to be confident in locating the cartridge appropriately and maintaining control without further restricting the visibility of the area to be shaved by the user's hand.

The handle length has been found to be an important vector with regard to consumer ease, comfort and control of use in the bikini area. Traditional razor handles have been found to be too long, whereas smaller travel products for example have been found to have a handle which is too short and or too wide for effective use in the pubic area.

Moreover, it has been found that the traditional long and thin handle shapes do not enable a safe, easy and complete hair removal process in the bikini area. This is believed to be due to the hold ergonomics and the necessary stroke directions required to remove hair from this particular area.

The handle suitable for use with the invention may have a length (hi) of from about 55 mm to 90 mm; preferably from about 60 mm to 80 mm, more preferably from about 70 mm to 80 mm. The handle may have a maximum width (h_{w}) of from about 45 mm to 25 mm, preferably from about 40 mm to 30 mm, more preferably from about 33 mm to about 37 mm. In one embodiment the handle has an aspect ratio of 2. The handle may have a maximum depth (ha) of from about 20 mm to 30 mm, preferably 22 mm to 36 mm, more preferably about 24 mm.

It has also further been found that in order to ensure a safe, easy and complete hair removal process, the handle should preferably exhibit a degree of flexibility in use and is preferably resiliently deformable. In one embodiment the handle material may have a Shore hardness in the range of from about 15 to 85 Shore A, preferably from about 15 to 45 Shore A, more preferably from about 15 to 25 A, most preferably about 20 Shore A).

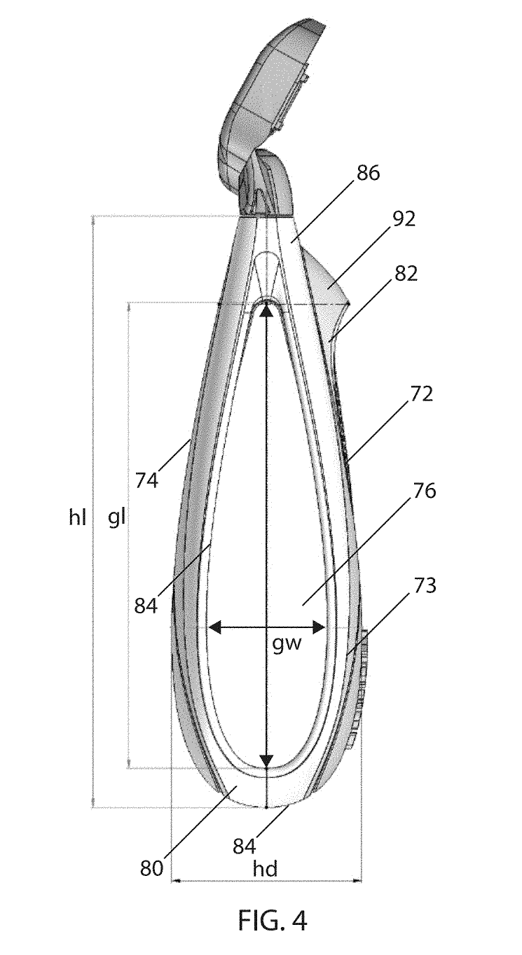

The handle has a body (70) which may be provided as a solid body or it may be provided as a body having a hollow body having a central void or gap (761). The overall shape of the handle may be for example generally oval or a partial tear drop shape or a U shape. The void or gap (76) may be enclosed or open from at least one side (88, 90) of the handle as shown in FIGS. 1a, 1b and 4 for example. The provision of a hollow readily enables the deformation of the handle material upon application of force by the user.

The handle typically has a front surface (72) and a rear surface (74). In one embodiment the handle has a hollow or gap (76) between at least a portion of the front (72) and rear (74) surfaces of the handle to thereby form a hollow (76) in the body. The front (72) and rear (74) surfaces are preferably connected to one another at least at the distal (84) and proximal ends (86) of the handle. The front (72) and rear (74) surfaces are not typically substantially connected along their respective side edges (88, 90) but only at the distal (84) and proximal ends (86).

In one embodiment, the handle is in the form of a loop or U shape as shown in FIGS. 1A, 1B and 4 whereby the front (72) and rear surfaces (74) form a central void or gap (76) in-between at least a portion of the surfaces and is contained thereby. The gap (76) may have a maximum length of from about 30 mm to 65 mm, preferably from about 40 mm to 60 mm, more preferably from about 50 mm to 60 mm. The aspect ratio of the handle length and the gap length is form about 1 to 2, preferably from about 1.2 to 1.3. The gap may have a maximum width of about 5 mm to 30 mm, preferably from about 10 mm to about 20 mm. The front (72) and rear surfaces (74) of the handle each have a respective inner surface (73, 75) adjacent the gap (76). The width of the front surface (72) and inner surface (73) and rear surface (74) and inner surface (75) is from about 10 mm to 20 mm, preferably between about 12 mm and 16 mm.

The provision of a gap in-between the front and rear surfaces readily enables the handle to be flexed by the user during use to apply pressure to the skin surface as and when necessary. Moreover, the flexibility enables the handle to be peeled away from the skin when the cartridge is in contact with the skin to enable visibility by the user during use.

In another embodiment at least a portion of the front and or rear surfaces (72, 74) are independently from one another flexible and deformable, preferably resiliently deformable so as to flex upon the application of pressure by the user.

In one embodiment at least a portion of the handle is at least partially, preferably substantially transparent. The peripheral edge (80) of the handle may be transparent or the centre of the handle may be transparent or the entire handle may be transparent. The transparent portions may also be coloured.

In one embodiment the handle may be provided in contrasting colours; for example the peripheral edge may be provided in one colour and the centre portion may be provided in a different colour.

The handle may be manufactured from any suitable material known in the art such as for example thermoplastics such as polypropylene, acrylonitrile butadiene styrene, high impact polystyrene, polycarbonate, polyphenylene ether/polystyrene blend, impact modified styrene acrylic copolymer, and/or mixtures thereof using standard manufacturing techniques. Suitable methods include injection moulding and die casting and optionally ‘additive or subtractive manufacturing’ techniques and or co-molding techniques.

In one embodiment the peripheral edge (80) of the handle may be formed from a material or mixture of materials selected for their strength, low density and ease of processing as a mold. In such embodiments the peripheral edge (80) is not deformable or flexible and thereby provides a rigid framework for the handle. A suitable material is impact modified styrene acylic copolymer (Zylar 960 available from INEOS Styrolutions).

The front and rear surfaces (72, 74) of this embodiment may be formed by co-molding the peripheral edge material (80) with a deformable material, such as a thermoplastic elastomer. In one embodiment the deformable material may have a shore hardness in the range of 15 to 85 Shore A, preferably 20 to 45 Shore A, thereby allowing the front and rear surfaces of the handle to touch under a palmer pinch grip, and return to the original non-deformed shape under normal usage. Such materials are chosen for their strong adhesion to the peripheral edge framework. These materials also permit a translucent finish and facilitate ease of manufacture in moulding or vacuum casting.

The front and or rear surfaces (72, 74) may further be provided with a tactile surface (82) to provide improved grip to the user during use. This may assist in providing reassurance to the user of a secure grip when the product is used in a wet and slippery environment.

In one embodiment the tactile surface (82) is provided in the centre portion of the front and or rear surface of the handle. Suitable tactile surfaces include raised portions in the form of bumps, ridges, dips etc. The tactile surface may in addition also provide a visual cue or a logo or branding on the front and or rear surface.

In one embodiment the tactile surface (82) is provided on the front surface (72) to provide a finger rest (92) and or may be located on a raised portion of the front surface (72), preferably at the proximal end (84) to form a finger rest. The finger rest (92) ensures the finger does not slip onto the back of the cartridge. Additional grip may be provided from an extruded logo located on the rear surface (74) of the handle. Another tactile surface (82) providing a gripping portion may be provided at the distal end (86) of the handle.

Tactile surface (82) maybe be provided by the material of the handle itself or it may be provided as a separate layer. The tactile surface maybe coloured differently from the front and rear surface to provide a visual cue to users.

Whilst not being bound by theory, the Applicant believes that the deformable nature of the handle may help to reduce and balance the blade load by acting as a suspension system, cushioning the load transferred to the cartridge from the handle and therefore the discomfort which can be associated with high blade angles. The smaller handle size enables the user to have a large amount of control over the razor which is needed when using blades which may cause discomfort. This also improves the safety of high blade angle embodiments.

Test Data

The Applicant has conducted the following test to demonstrate the improved performance of the claimed invention.

The skin redness associated with the use of the inventive Mach 3 high angle blade (50 degrees) contained in a Mach 3™ manual product versus commercially available Mach 3 (having blade angles of 23 degrees) manual product in female bikini area was assessed by both expert visual grading and spectrophotometer analysis. The test involved the visual grading and spectrophotometer assessment comparing skin irritation (change from base line at 6 hrs, 24 hrs, 48 hrs and 72 hrs after the first and second shave) verses a control site. These timepoints are relevant with regard to the rate of hair regrowth and the opportunity for hair to re-penetrate the skin.

Test Participants

Subjects were between the ages of 19 and 35 with the average age being 29 years old. Four Subjects were Left Handed and 21 were Right Handed. Randomization was stratified within dominant hand. All Subjects were Caucasian. Subjects were Fitzpatrick Skin Types II-IV. The users shaved according to their normal habits.

Participants were included in the test sample if:

Female, 18-35 years old, premenopausal (self-declared), Fitzpatrick Skin Type I to IV, Uses a 3 blade or more cartridge razor system (no electric razors) for shaving the bikini area 2+times per week; has Ingrown hairs or raised bumps at “moderate” or “severe” after shaving (self-declared); has observed bumps (defined as >2 papule/pustule at Visit 1).

Participants were excluded if:

Pregnant, lactating or planning to become pregnant, has immunologic or infectious disease, skin condition, or taking medication which could place subject at risk or interfere with accuracy of study results, has ever used laser or intense pulsed light (IPL) hair removal in bikini area; has used depilatories or waxing in bikini area within last 2 months.

The following visual grading scale was used and conducted by grading experts

0: no redness/erythema
1: faint redness/erythema
2: light red colouration
3: moderate red coluration
4: bright red colouration

Results

The visual grading showed that 48 hours after the second shave the inventive product had only 29% worsened redness verses 50% for the comparative product and that and that redness as a percentage of shaved area was 46% for the comparative product verses 29% for the inventive product. Thus the data shows that the redness is reduced after multiple uses of the inventive product.

Spectrophotometer grading showed that after the first shave the amount of redness for the inventive product reduced and normalized after 6 hours and 24 hours whereas the comparative product did not reduce or normalize over this time period.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor comprising a cartridge comprising a housing having a front portion and a rear portion, a guard at the front portion of said housing and a cap at the rear portion of the housing and a blade array located in-between the guard and cap, wherein the blade array comprises at least two blades, a primary blade and a final blade, each blade having a blade edge that extends parallel to the housing; having a blade plane x tangential to the primary blade edge and the final blade edge, wherein each angle between each blade and the blade plane x is about 45° or greater.

2. The use of a razor cartridge according to claim 1, for the removal of hair from the pubic area, preferably the bikini area.

3. A shaving razor according to claim 1, wherein each blade has an angle of from about 45° to about 60°.

4. A shaving razor according to claim 1, wherein said cartridge has a skin contacting surface foot print of from about 600 mm2 to about 800 mm2.

5. A shaving razor according to claim 1, wherein said front portion of said housing is shorter than said rear portion of said housing.

6. A shaving razor according to claim 1, wherein the aspect ratio of said front and rear portions is from about 2 to about 1.

7. A shaving razor according to claim 1 wherein said cartridge has a generally oval shape.

8. A shaving razor according to claim 1, wherein said cartridge comprises at least one lubricating member.

9. A shaving razor according to claim 1, further comprising a handle permanently or releasably connected to said cartridge.

10. A shaving razor according to claim 9, wherein said handle is flexible and or/deformable.

11. A shaving razor according to claim 9, wherein said handle has a length of from about 55 mm to about 90 mm and a maximum width of from about 45 mm to about 25 mm.

12. A shaving razor according to claim 9, wherein said handle has a Shore A hardness of about 15 to about 85.

13. A shaving razor according to claim 9, wherein said handle has a body having a gap.

14. A shaving razor according to claim 13, wherein said handle has a front surface and a rear surface, wherein said gap is between said front and rear surfaces.

15. A shaving razor according to claim 9, wherein said handle has a rigid peripheral edge.
